(19) United States
(12) Patent Application Publication
(10) Pub. No.: US 2014/0109738 A1
(43) Pub. Date: Apr. 24, 2014

(54) Watermelon Slicer

(71) Applicant: Daniel G. Schwartz, Horseheads, NY (US)

(72) Inventor: Daniel G. Schwartz, Horseheads, NY (US)

(21) Appl. No.: 13/659,162

(22) Filed: Oct. 24, 2012

(51) Int. Cl. A47J 17/00; B26D 1/04

(52) U.S. Cl. 83/23; 99/584; 99/591; 83/39

(57) ABSTRACT

A slicer device for slicing and removing a fleshy part of a watermelon surrounded by a rind. The slicer devices comprises a cutter piece having an outer surface and an inner surface; and a series of cutters of a thickness attached to the inner surface of the cutter piece spaced apart, connected to each other and arranged to form a pattern with openings, the openings defined by the cutter sand the inner surface of the cutter piece for receiving and slicing the fleshy part of the watermelon from the rind.

### BACKGROUND OF THE INVENTION

1. Field of the Invention

The invention pertains to the field of food slicers. More particularly, the invention pertains to a watermelon slicer.

2. Description of Related Art

Slicers of vegetables and fruit have been used in the past to ease the removal of the edible portion of the vegetable or fruit for consumption by a user. For example, U.S. Pat. No. 4,546,545, entitled, “Pineapple Cutter” by Hirano discloses a pineapple cutter with a cylindrical body having a cutting edge at the surface end of the lower portion, a pair of handles connected to the outer surface of the cylindrical body, a pressing sheet mounted on the inner portion of the cylindrical body slidable in the vertical direction and a pushing member secured to the upper portion of the cylindrical body connected with the pressing sheet. A second pressing sheet with a smaller diameter than the pressing sheet is located within the pressing sheet to core the pineapple. When used to cut the pineapple, the rind is removed at the same time the core of the pineapple is removed. The exposed cutting edges of U.S. Pat. No. 4,546,545 cause user safety risk. U.S. Pat. No. 4,546,545 could even be seen as an ejector assembly to deal with the obvious difficulty of removing pineapple from the cutter device of Hirano's U.S. Pat. No. 4,490,912.

U.S. Pat. No. 1,744,422, entitled “Fruit and Vegetable Cutter” by Taylor discloses a handle with detachable cutting head. The detachable cutting head is attached to the handle and a funnel type cylindrical portion with through threads. This cutter dices the entire vegetable or fruit including the outside skin. This cutter could not be used for a watermelon for example, because to push the cutter inside of the watermelon flesh, the screw thread connection would be too thick and additionally the holder around the funnel portion of the cutter would also not be able to be pushed through the watermelon flesh. Furthermore, the cutter can only accommodate items which fit entirely within the cutting circle.

U.S. Pat. No. 4,490,912, entitled “Pineapple Cutter” by Hirano discloses a pineapple cutter with handles attached to a cylinder which has a cutter portion. The cylinder of the pineapple cutter is adapted to punch the outer peel and the interior of the pineapple to separate the peel from the interior of the pineapple. The pineapple cutter cuts into the outer peel of the pineapple in order to separate it from the interior of the pineapple. Furthermore, based on the design and the need to “punch” the pineapple cutter through the pineapple in order to slice it, softer flesh, such as the interior of a watermelon would be significantly damaged in the process of removing the flesh from the cutter assembly as described in this patent.

Therefore, there is a need for a watermelon slicer that can remove the fleshy interior or meat of the watermelon without cutting into the rind.

### SUMMARY OF THE INVENTION

The watermelon slicer of the present invention allows a seedless watermelon to be quickly and efficiently sliced into pieces, for example ‘log’ shaped pieces or other shaped pieces with minimal time and effort. The device will cut watermelon meat into slices with a single motion, with no outside supports or guides, or other moving parts. The device slices the meat of the melon and does not slice or cut into the rind. After pushing the cutter through the meat or fleshy interior of the watermelon, a portion of the meat of the watermelon is cut into pieces by the fixed blades in the slicer device. This device requires no outside alignment, guides or supports. It only slices the fleshy interior or meat of the watermelon.

The slicer device has a cutter piece with an outer surface and an inner surface, cutter blades or wires fastened to the inner surface of the cutter piece, arranged to form a pattern with openings, the openings defined by the cutters and the inner surface of the cutter piece for receiving and slicing the fleshy part of the watermelon from the piece, at least one push bar connected to the cutter piece and/or the cutting blades, and an optional cross handle connected to the at least one push bar for easy handling of the device.

Optionally, a separate push plate, external to the slider device, may be aligned with the cutter piece and includes grooves that can receive the cutter blades to ease clearing the inner meat portion of the watermelon from the cutter blades, if necessary.

The slicer device may also be incorporated into a larger mechanical device in order to permit faster and/or easier use for production type application. Furthermore, the slicer device may be incorporated into a machine for semi- or automatic operation.

The cutter blades may be made out of stainless steel or other strong, easily cleanable material and may be secured in a multitude of alignment patterns.

The slicer device of the present invention can slice the inner, meatier part of the watermelon without the slicer device cutting into the rind. It should be noted that the melon slicer is not a long continuous cylinder, as this would cause the watermelon to be trapped in the cutting device. Instead, only narrow blades or wires are used to slice the melon still within the rind. The design of the supporting bars of the slicer device allows the slicer to ‘reach’ into the meat of the watermelon being cut, with the issues associated with continuous long slicing knives or shapes, which would trap the meat and make removal of the meat from the slicer device difficult.

To use the slicer device of the present invention, the top and bottom crown of the melon are sliced off, resulting in a flat top portion and a flat bottom portion. The watermelon is placed upright to rest on the flat top portion or the flat bottom portion. A user then aligns the cutting piece with the fleshy part or meat of the watermelon. Pushing down on the supporting bar(s) or the handle forces the fleshy part or meat of the watermelon through the cutter piece. If the slicer device has blades or wires within the cutter piece, the openings between the blades or wires, defined the shape of the cut watermelon. The shaped pieces are dependent upon the pattern of wires or blades attached to the inner surface of the cutter piece. It should be noted that the device cannot be rotated once inside of the watermelon, since the cutter blades would otherwise destroy or mush the watermelon meat.

After the slicer device has been pushed through the fleshy part or meat of the watermelon, there may be times in which the meat of the watermelon may be slightly lodged within the slicer device. To easily remove the meat of the watermelon lodged within the slicer device, the blades or cutter piece of the slicer device are aligned with the grooves of the push plate and as the slicer device is pushed down onto the plate, such that the cutters are received by the grooves of the push plate. The downward movement of the slicer device relative to the push plate causes the raised portions to push the fleshy part of the melon out of the openings between the blades and the cutter piece. The raised portions defining the grooves push the meat of the watermelon out of the openings between the cutters and the cutter piece easily and efficiently, without having a user place their fingers near the cutting edges of the slicer device. The optional push plate may or may not be used depending on the construction of the slicer device and the density characteristics of the particular melon being sliced.

### BRIEF DESCRIPTION OF THE DRAWING

FIG. 1 shows a slicer device in an embodiment of the present invention.

FIG. 2 shows an isometric bottom view of a device in an embodiment of the present invention.

FIG. 3 shows an angled view of the push plate.

FIG. 4 shows a top view of the push plate.

FIG. 5 shows the blades being received by the grooves of the push plate.

FIG. 6 shows a close up view of the blades of the slicer device being received by the grooves of the push plate.

FIGS. 7a and 7b show views a scraper in an embodiment of the present invention.

FIG. 8a shows a schematic of a watermelon before the top and bottom crown is removed and the resulting watermelon after the top and bottom crowns have been removed.

FIG. 8b shows a bottom view of the watermelon after the bottom crown has been removed.

FIG. 8c shows a schematic of aligning the slicer device with the watermelon.

FIG. 8d shows a schematic of the slicer device moving through the meat of the watermelon.

FIG. 8e shows a schematic of the bottom of the slicer device after being pushed through the meat of the watermelon.

FIG. 8f shows a schematic of the watermelon after the slicer device has been used on the meat of the watermelon, and the slicer has been removed.

FIG. 9 shows a scraper being used to remove the fleshy part of the watermelon from the rind after the slicer device has been used if there is any remaining melon to harvest.

FIG. 10 shows another view of the bottom of the slicer device in a first embodiment of the present invention.

FIG. 11 shows an alternate pattern of cutters attached to the cutter piece.

FIG. 12 shows another pattern of cutters attached to the cutter piece.

FIG. 13-14 shows a scraper of an alternative embodiment.

FIG. 15 shows an alternative embodiment of the scraper of FIGS. 7a and 7b.

FIG. 16 shows a slicer device an embodiment of the present invention which only has one support bar.

FIG. 17 shows another view of a slicer device of the present invention which only has one support bar.

FIG. 18 shows a slicer device of an embodiment of the present invention which uses the cutter piece to remove the meat of the watermelon.

FIG. 19 shows another view of a slicer device of an embodiment of the present invention which uses the cutter piece to remove the meat of the watermelon.

### DETAILED DESCRIPTION OF THE INVENTION

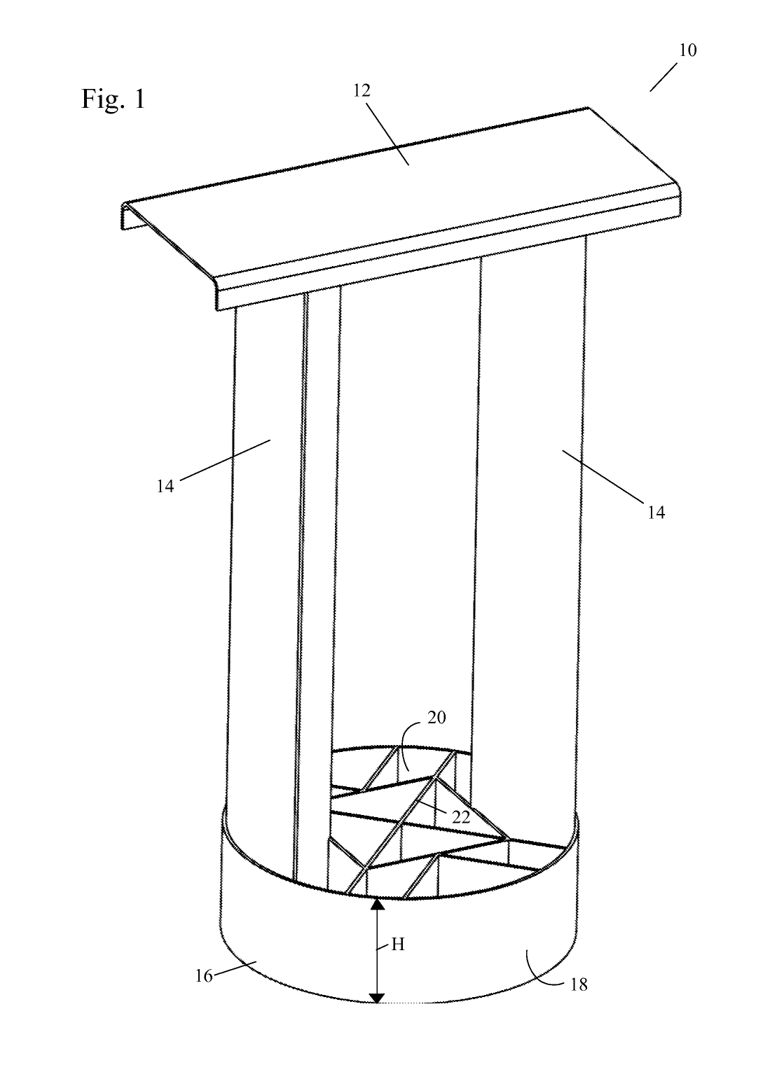

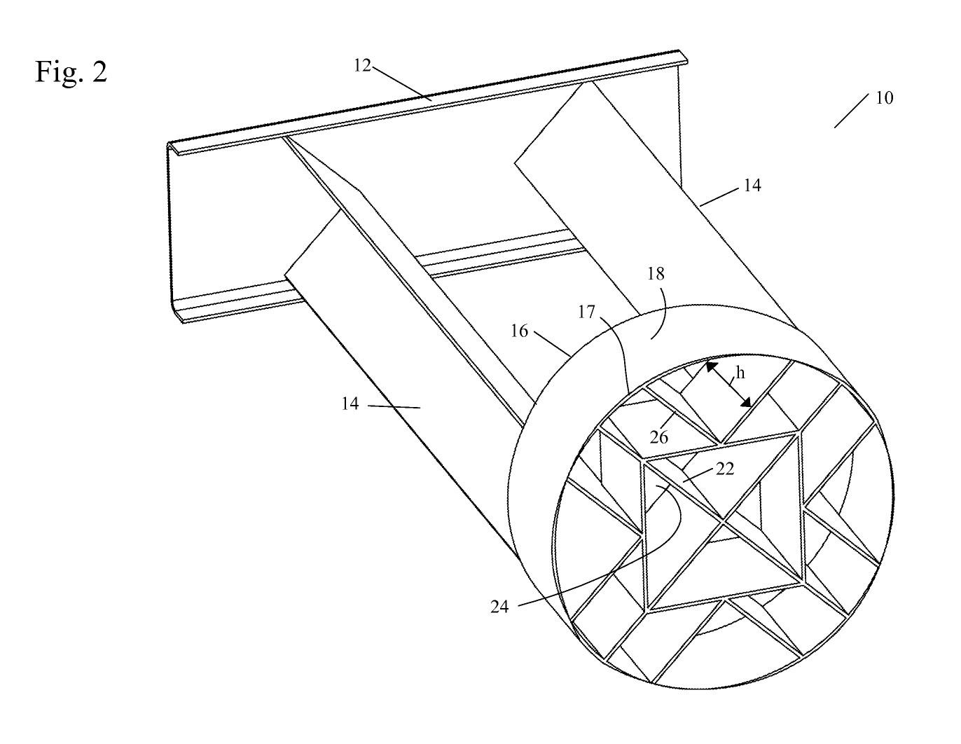

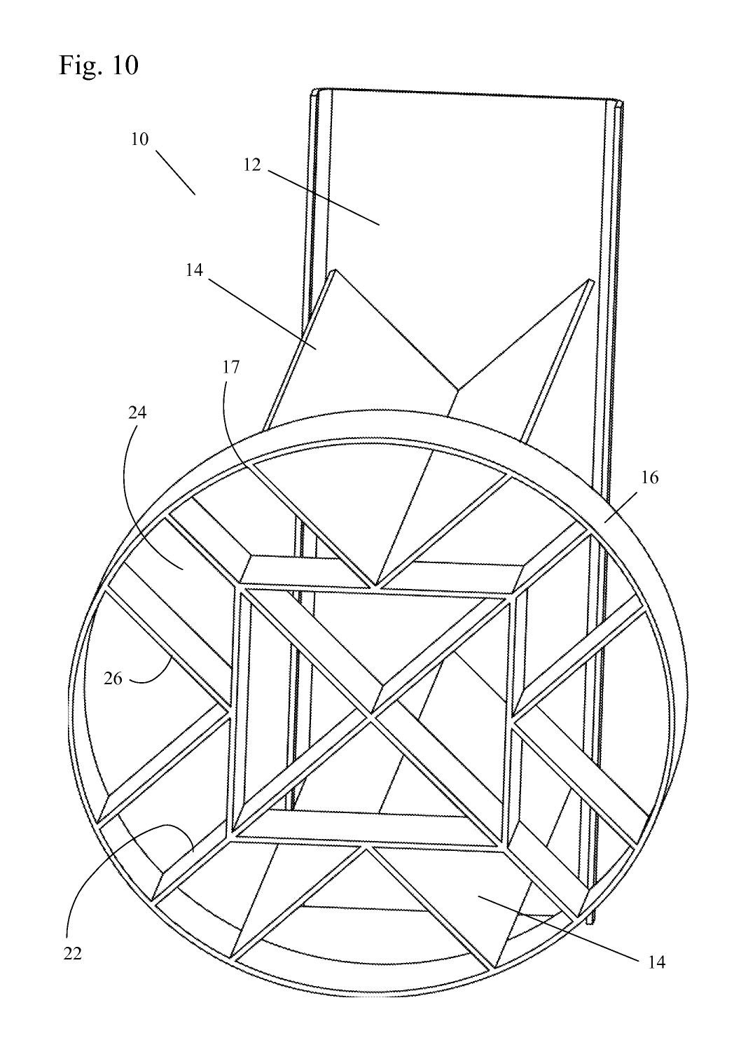

FIGS. 1-2 and 10 show a slicer device 10 in an embodiment of the present invention. The slicer device 10 has a cutter piece 16 with an outer surface 18 and an inner surface 20. The cutter piece 16 has a height H. Attached to the inner surface 20 of the cutter piece 16 is a series of cutter blades 22. In an alternate embodiment, the cutter blades 22 may be replaced with wires attached to the inner surface 20 of the cutter piece 16.

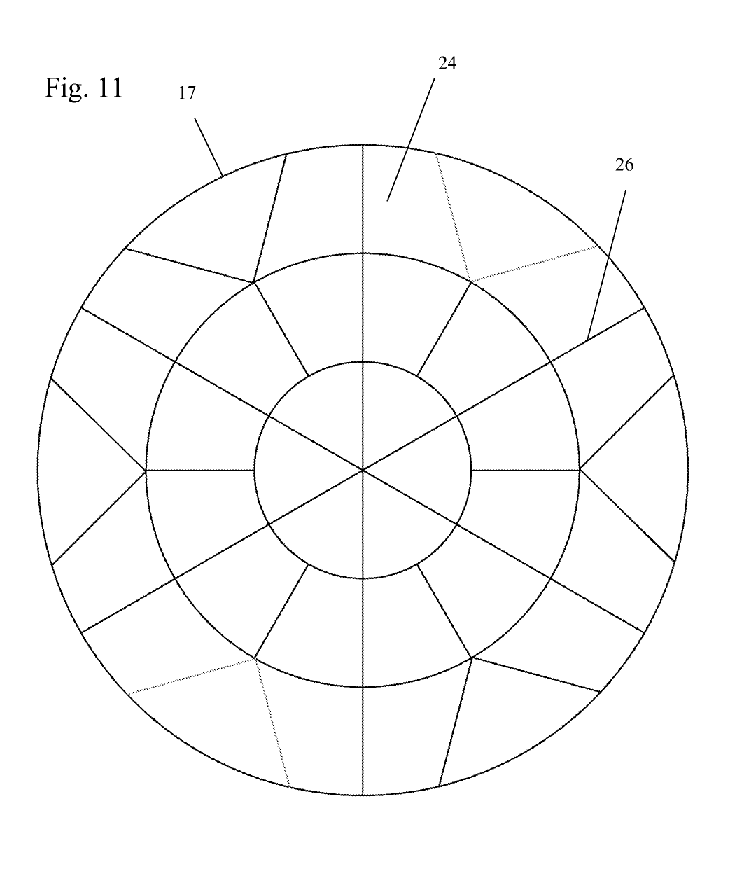

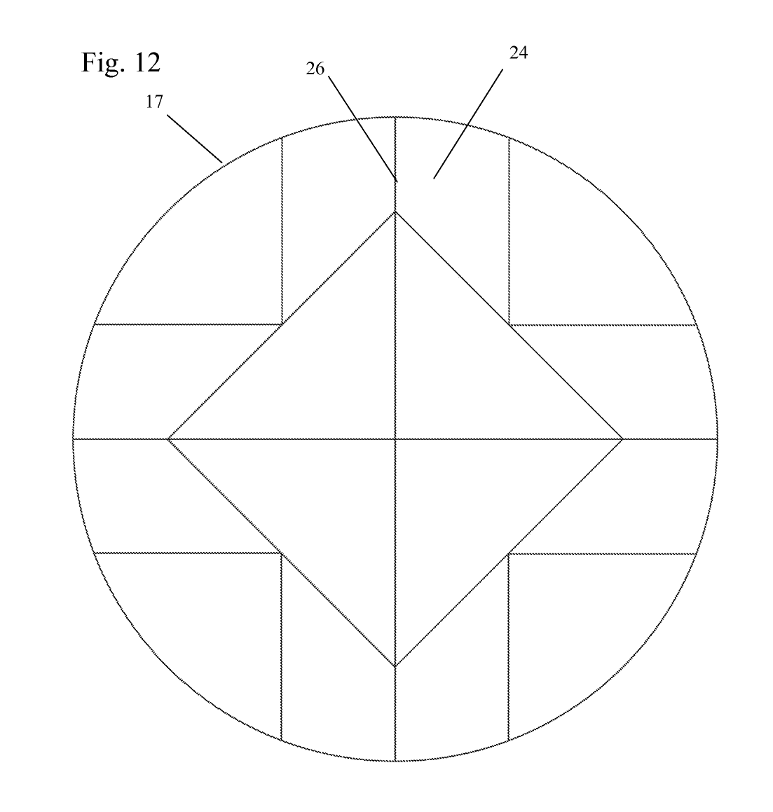

The series of cutter blades 22 are placed relative to each other within the inner surface 20 of the cutter piece to define openings 24 between the individual cutter blades 22. The cutter blades 22 are connected to each other and the inner surface of the cutter piece 16. The pattern of openings 24 and cutter blades 22 is not limited to the patterns shown. Examples of alternate patterns are shown in FIGS. 11 and 12. It should be noted that the shape of the openings 24 defines the shape into which the watermelon meat or flesh will be sliced. In addition to geometric shape symbols, decorative shapes (e.g. animals, logos, or figures) could be formed. The cutter blades 22 have a cutting edge 26 and a height h that is equal to the height H of the cutter piece 16. It should be noted that the cutter piece may 16 also have a cutting edge 17. The cutter blades 22 also have a thickness.

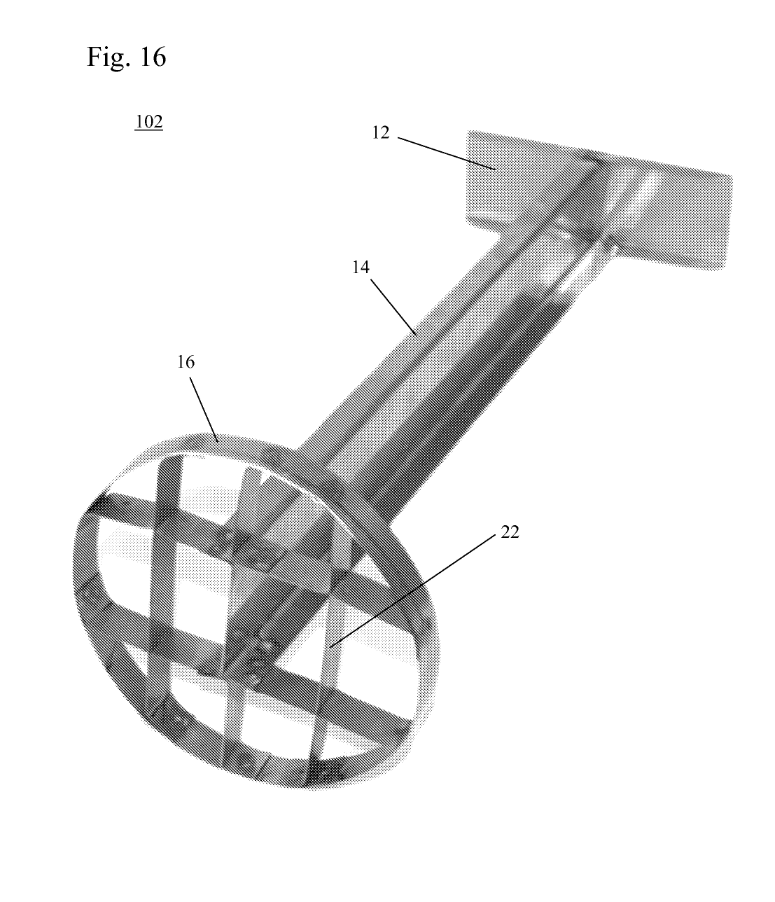

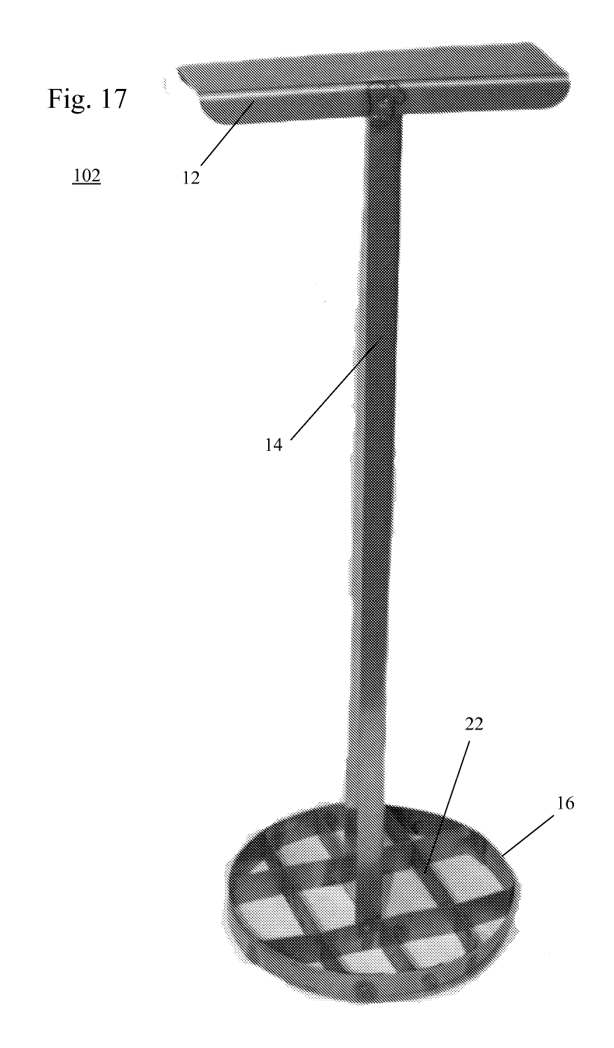

In one embodiment, at least one of the cutter blades 22 is attached to support bar(s) 14 that extend axially from the cutter piece 16. In another embodiment, the support bar(s) 14 are attached to the inner surface 20 of the cutter piece 16 and at least one of the cutter blades 22. The support bar(s) 14 have a thickness that is the same or less than the thickness of the cutter blades 22 or the cutter piece 16 itself. At least one cross handle 12 may attach to the support bars 14 to provide an increased surface area in which to push the slicer device 10 through the meat of the watermelon and ease the overall use of the slicer device. An example of the slicer device 102 with one support bar 14 attached to a cross handle 12 is shown in FIGS. 16-17.

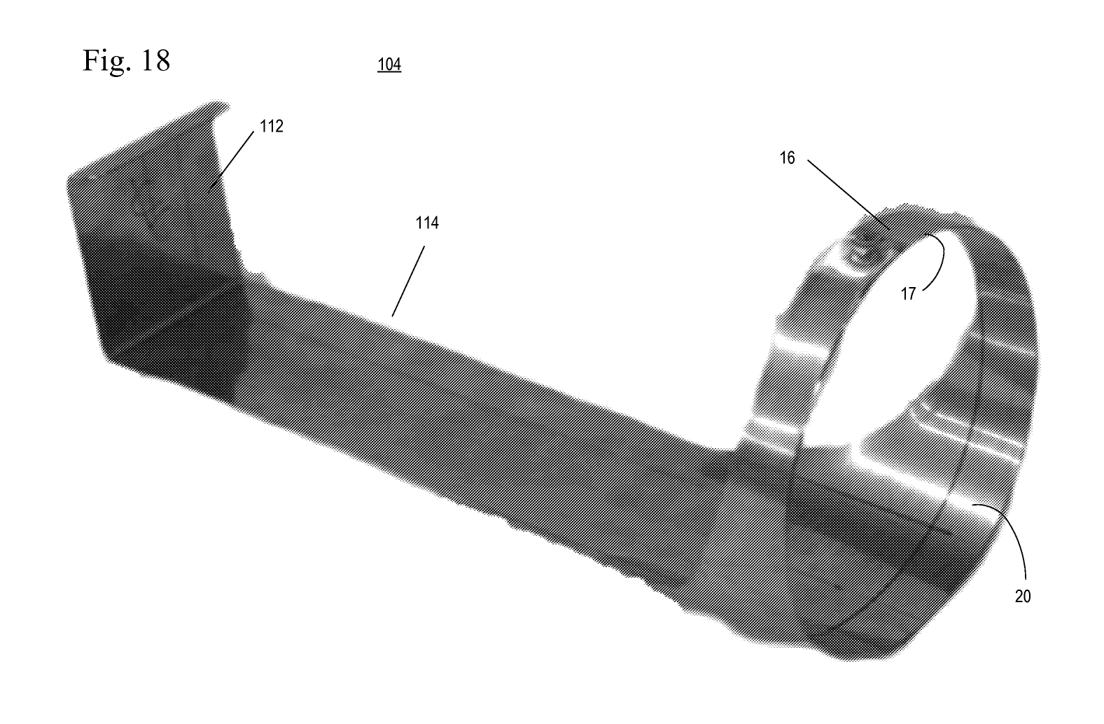

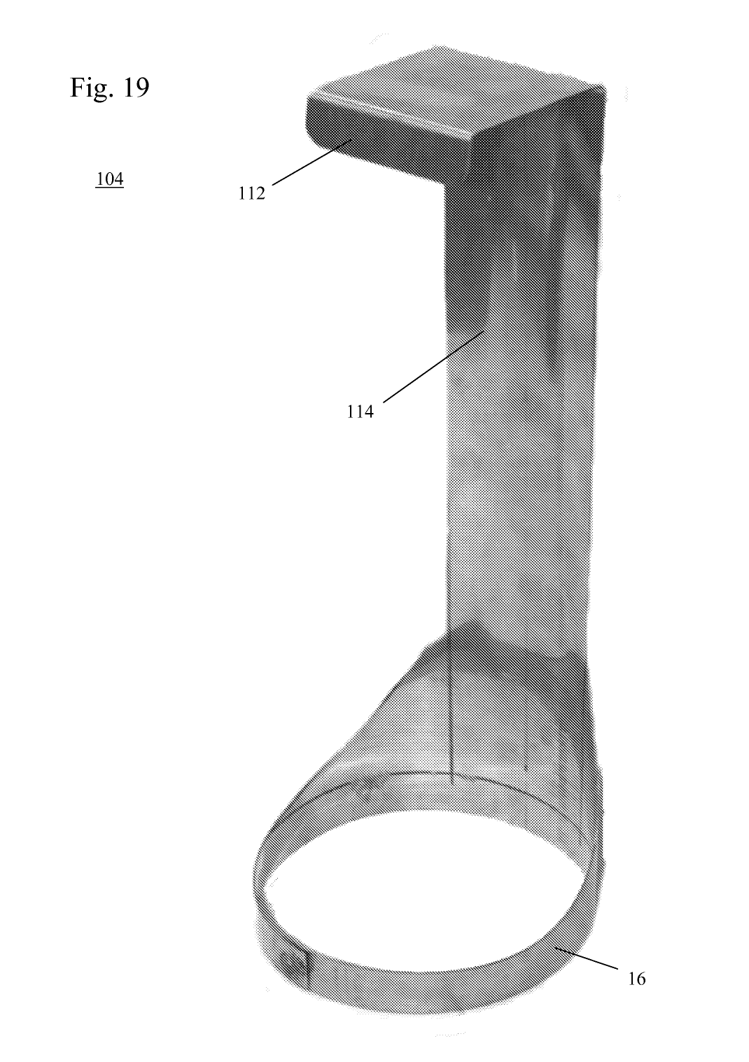

In another embodiment, the cutter piece 16 does not have any cutter blades attached to the inner surface 20 and only the edge 17 of the cutter piece 16 itself cuts the meat of the watermelon as shown in FIGS. 18-19. As shown in FIGS. 18-19 of an alternative slicer device 104, the support bar 114 is formed integrally with the cutter piece 16 and a handle 112. The edge 17 of the cutter piece 16 cuts the meat 7 of the watermelon 2.

In an alternate embodiment, an additional, larger cutter piece in diameter or width than cutter piece 16 may be removably attached to the cutter piece 16 for removing meat 7 of larger diameter watermelons. The larger cutter piece may include additional cutter blades.

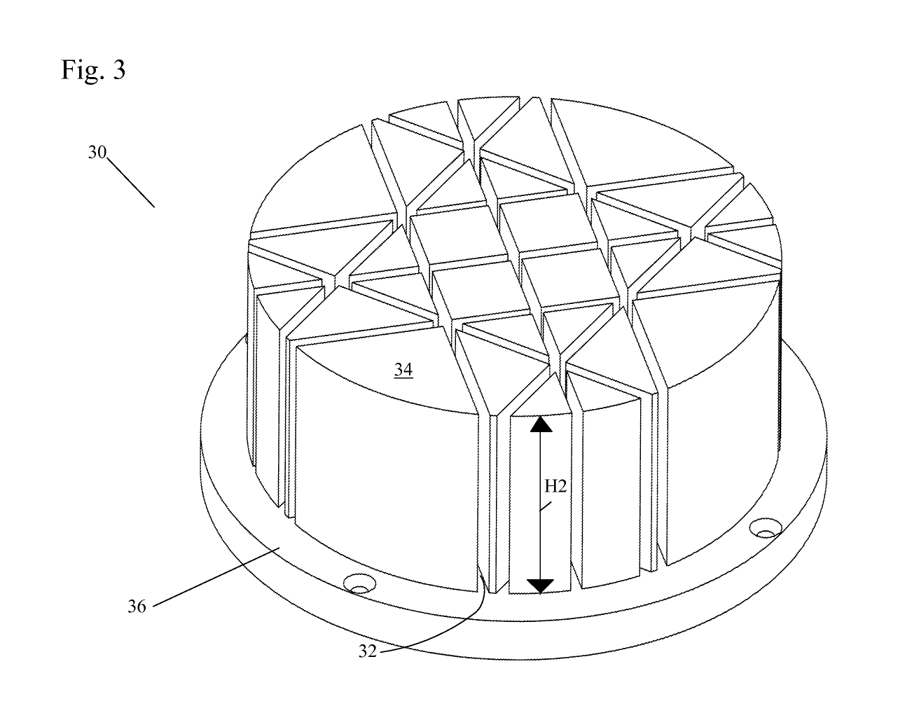

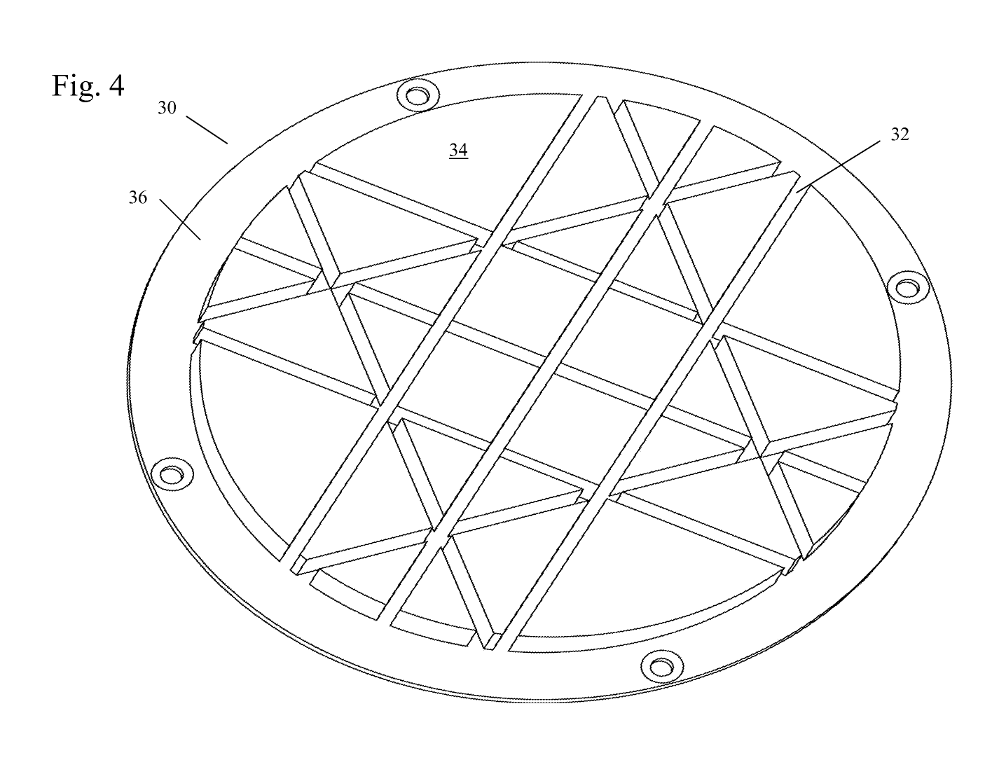

FIGS. 3-4 show a separate push plate 30, external to the slicer device 10, 102 that may be aligned for receiving the cutter blades 22 of the slicer device after the slicer device has been pushed through the fleshy part of the watermelon. The push plate 30 has a base portion 36 with an outer surface that is larger, smaller or equal to the outer surface of the cutter piece 16. A series of grooves 32 and raised portions 34 axially extend out from the base portion 36. The raised portions 34 have a height H2. The raised portions 34 aid in clearing the fleshy interior or the meat of the watermelon from the cutter piece 16 and cutter blades 22. The pattern of openings 24 and placement of the cutter blades 22 of the cutter piece of the slicer correspond to the pattern of grooves 32 and raised portions 34 of the push plate 30.

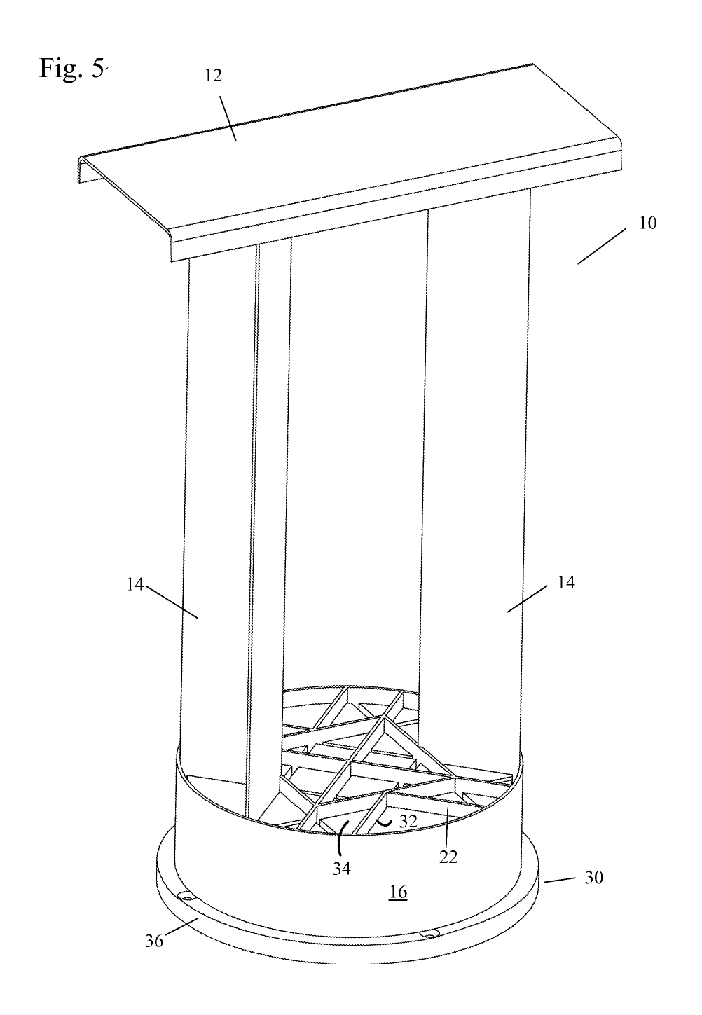

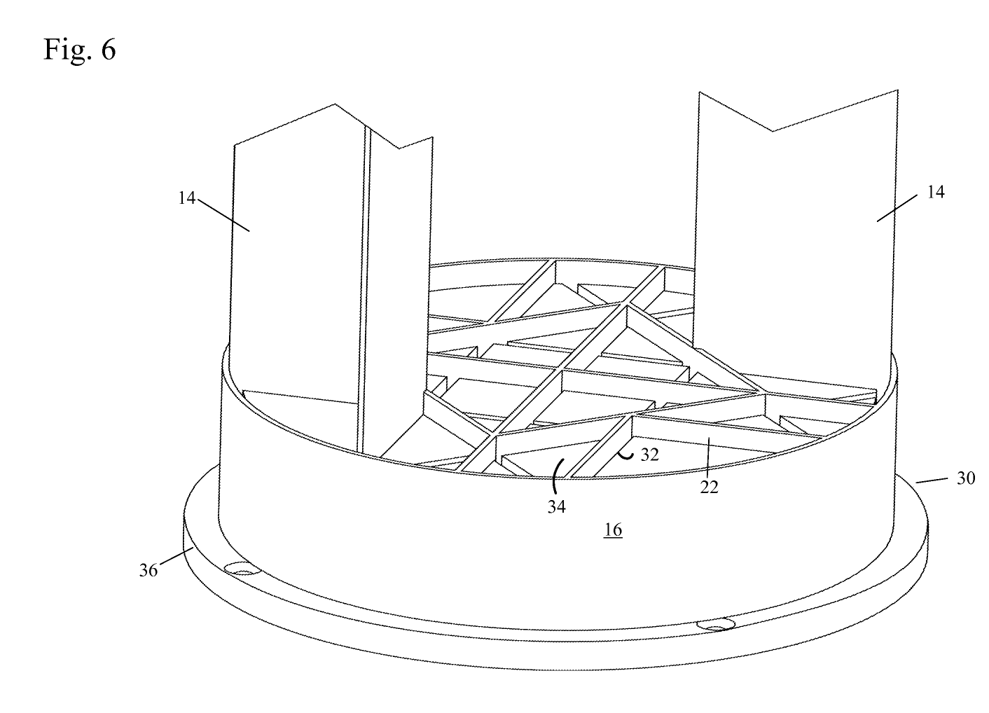

FIGS. 5-6 show the slicer device 10 aligned with the separate push plate 30. When the cutter piece 16 is aligned with the slicer device 10, the series of grooves 32 of the push plate 30 receive the cutter blades 22 and the raised portions 34 of the push plate 30 are received by the openings 24 formed by the cutter blades 22. It should be noted that the height H2 of the raised portions 34 of the push plate 30 are preferably less than the height H of the cutter piece 16 or the height h of the cutter blades 22. Alternatively, the height of the raised portions 34 of the push plate may have a height H2 equal to the height H of the cutter piece 16 and the height h of the cutter blades 22.

The grooves 32 and the raised portions 34 of the push plate 30 may be arranged in patterns other than the pattern shown in the drawings within the scope of the invention.

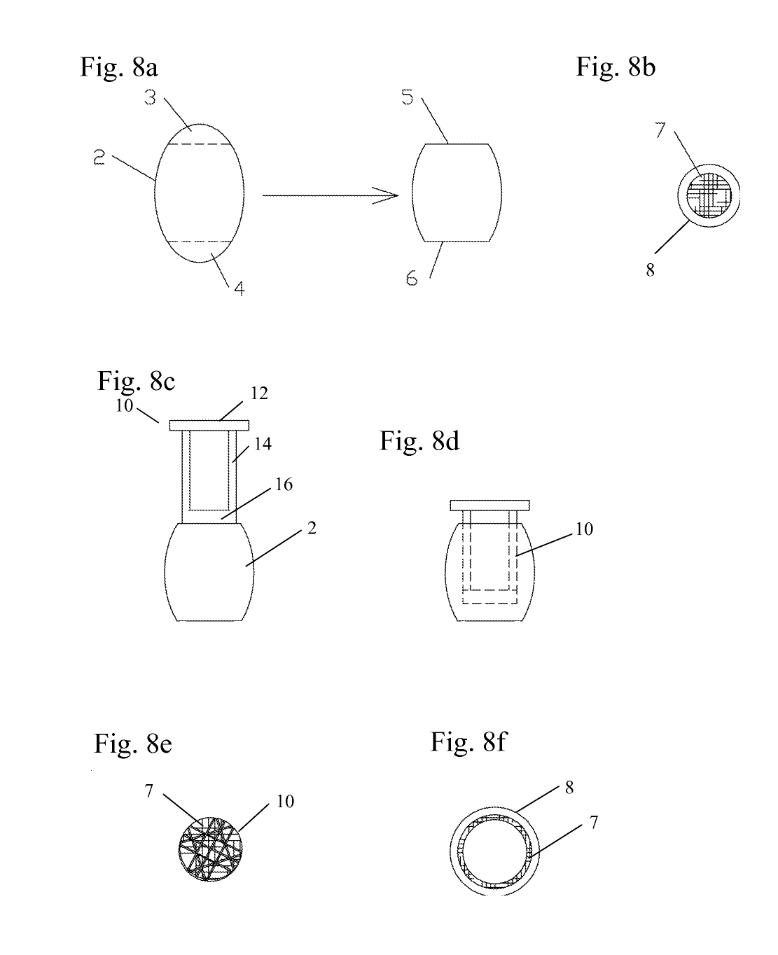

FIGS. 8a-8f shows steps of using the slicer device 10 to remove the fleshy interior or meat 7 of the watermelon 2 from the rind or outer portion 8 of the watermelon 2. In a first step, a user removes a top and bottom crown 3, 4, of the watermelon 2, resulting in a flat top portion 5, and a flat bottom portion 6 as shown in FIG. 8a. A bottom view of the watermelon is shown in FIG. 8b.

The watermelon 2 is placed upright to rest on the flat top portion 5 or the flat bottom portion 6 as shown in FIG. 8c. A user then aligns the cutting piece 16 of the slicer device 10 with the fleshy part or meat 7 of the watermelon 2 and pushes, shown in FIG. 8d, using the supporting bar(s) 14 or the handle(s) 12 to push the fleshy part or meat 7 of the watermelon 2 through the openings 24 between the cutter blades 22 or wires, or the opening defined by the inner surface 20 of the cutter piece 16 itself, cutting the fleshy part 7 of the watermelon 2 into shaped pieces shown in FIG. 8e. The shaped pieces are dependent upon the pattern of wires or blades attached to the inner surface of the cutter piece. It should be noted that the pushing of the slicer device through the meat 7 of the watermelon is a straight, linear action without simultaneous rotation of the slicer device 10. The watermelon that is left behind is a hollowed out ring of rind 8 with a small amount of fleshy part or meat 7 attached to the rind 8 as shown in FIG. 8f. The rind 8 is never cut into by the slicer device 10.

A similar method may be used to remove the fleshy interior or meat 7 of the watermelon 2 from the rind or outer portion 8 of the watermelon using the slicer devices 102, 104 of alternative embodiments shown in FIGS. 16-19.

Should the user desire to consume the fleshy interior 7 of the watermelon 2 at another time, alternatively, the user removes a top crown 3 of the watermelon 2, resulting in a flat top portion 5 and the user aligns the cutting piece 16 of the slicer device 10, 102, 104 with the fleshy part or meat 7 of the watermelon 2 and pushes, using the supporting bar(s) 14, 114 or the handle(s) 12, 112 to push the fleshy part or meat 7 of the watermelon 2 through the openings 24 between the cutter blades 22 or wires, or the opening defined by the inner surface 20 of the cutter piece 16 itself, cutting the fleshy part 7 of the watermelon 2 from the rind 8. It should be noted that the pushing of the slicer device through the meat 7 of the watermelon is a straight, linear action without simultaneous rotation of the slicer device 10. Then, the user would pull back and remove the slicer 10, 102, 104 from the watermelon 2 only. When the user is ready to consume the watermelon 2, the user removes the bottom crown 4 of the watermelon 2, releasing the sliced interior flesh 7.

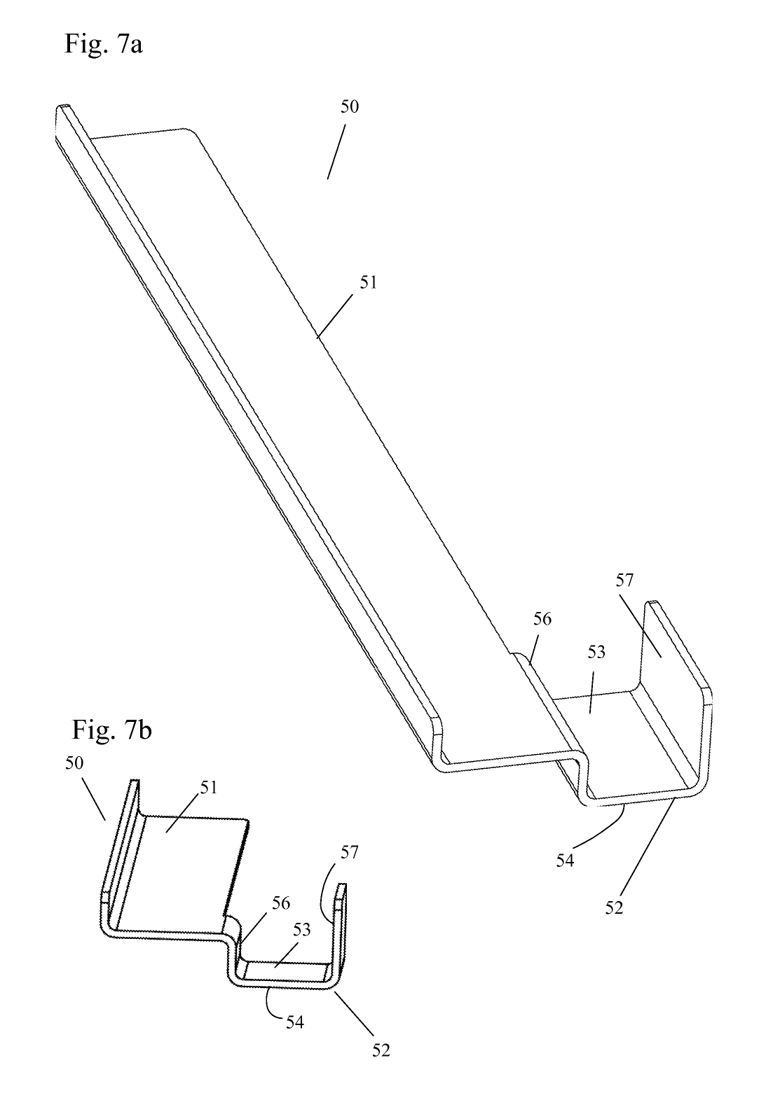

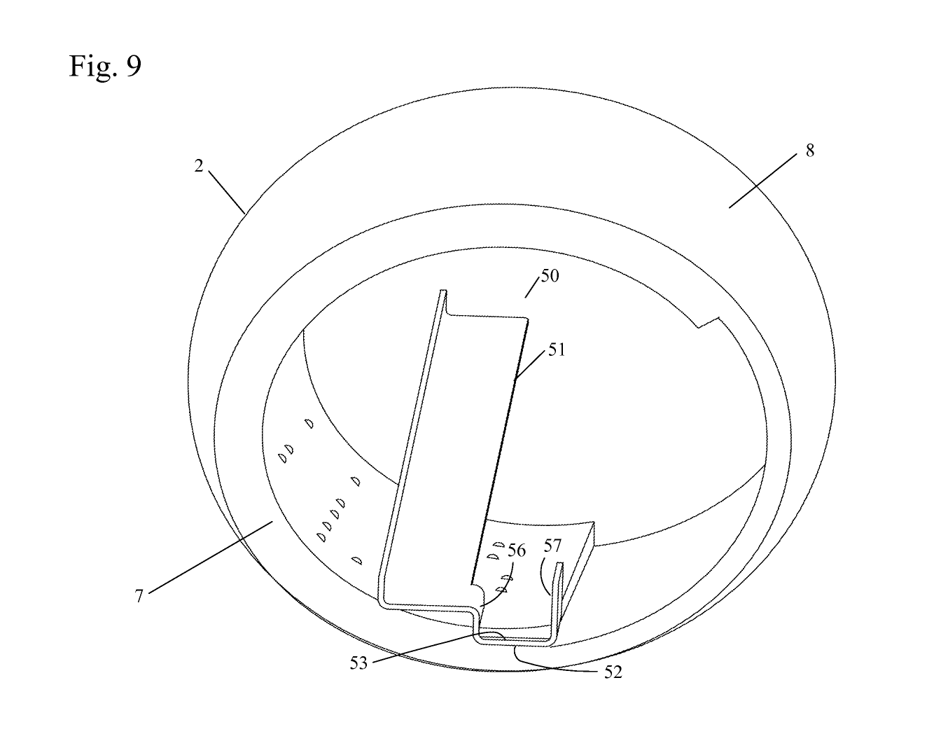

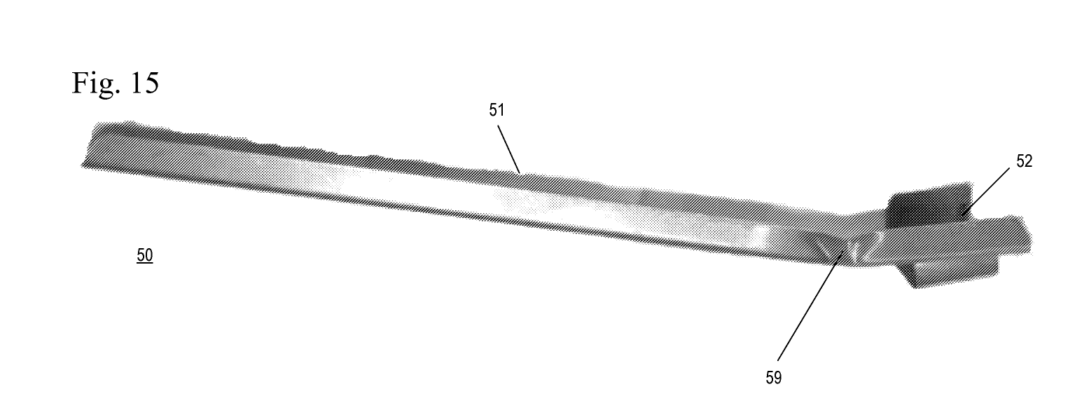

FIGS. 7a, 7b and 9 show a scraper 50 of a first embodiment that may be used after the slicer device 10, 102, 104 has been pushed through the fleshy part 7 of the watermelon 2 and the pieces removed from the slicer device 10, 102, 104, for example from the watermelon 2 shown in FIG. 8d. The scraper 50 has a handle 51 which is integrally formed with a bent scraping portion 52. The bent scraping portion 52 has a bottom surface 54, a top surface 58 with an edge 53, and opposing wall surfaces 56, 57. In an alternate embodiment, the handle 51 may be bent 59 at an angle relative to the bent scraping portion 52 to permit the user to more easily follow the contour of the watermelon 2 while scraping the fleshy interior 7 of the watermelon 2 as shown in FIG. 15.

To remove the remaining fleshy part 7 of the watermelon 2 after the slicer device 10, 102, 104 has been used, a user aligns an edge 53 of the bent scraping portion 52 with the fleshy part 7 of the watermelon 2 and pulls the scraper 50, such that the edge 53 cuts through the fleshy part 7 of the watermelon 2 from the rind 8 as shown in FIG. 9. The fleshy part 7 of the watermelon 2 that is cut or scraped off, slides across the top surface 58 of the bent scraping portion 52 and is cut into shaped pieces based on the placement of the opposing wall surfaces 56, 57 relative to the top surface 52 of the bent scraping portion 52.

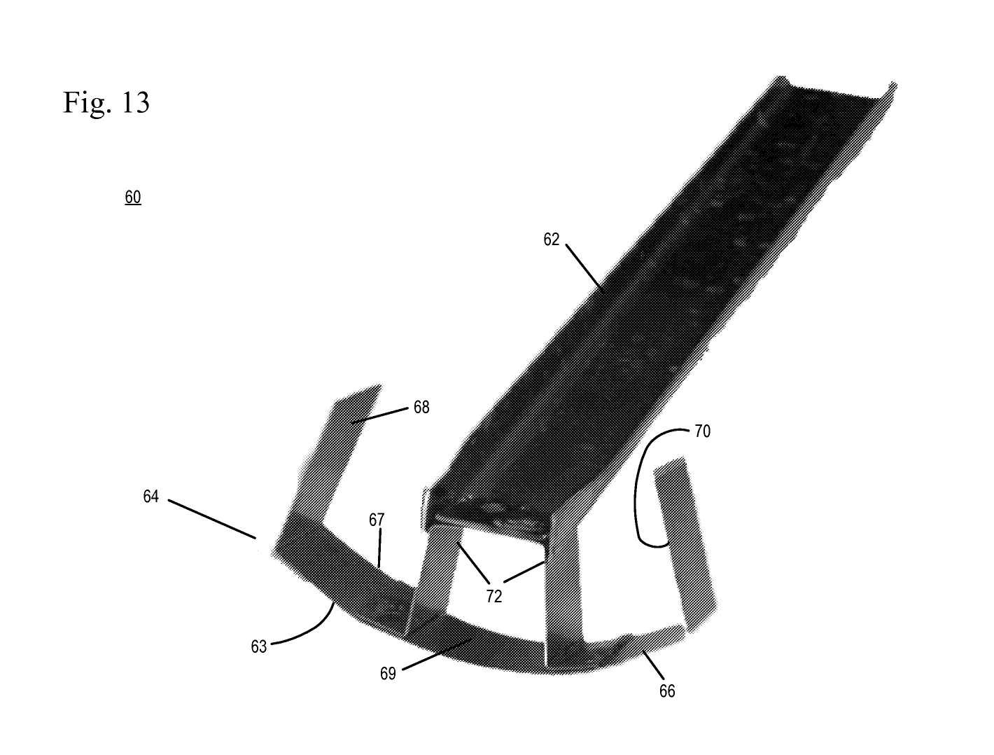

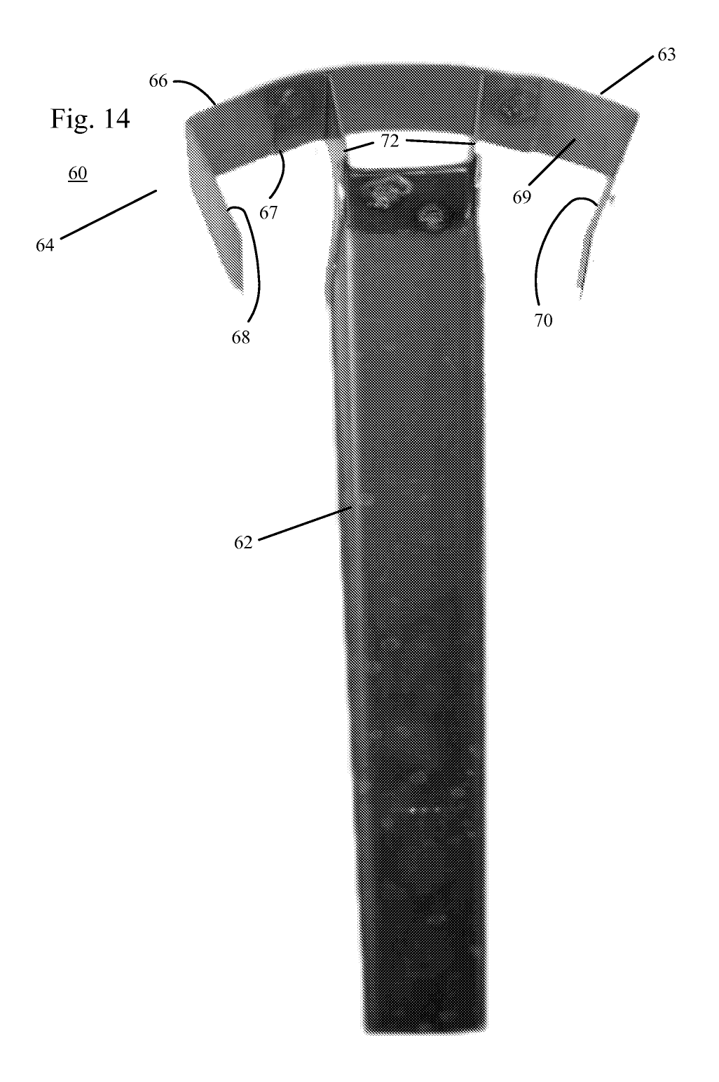

FIG. 13 shows a scraper 60 of an alternative embodiment. The scraper 60 may be used after the slicer device 10 has been pushed through the fleshy part 7 of the watermelon 2 and the slicer 10, 102, 104 with melon pieces has been removed from the melon, for example from the watermelon 2 shown in FIG. 8d. The scraper 60 has a handle 62 which is coupled to a scraper head 64 through a connecting portion 72. The scraper head 64 has a scraping portion 66 with a top surface 69, a bottom surface 63 and opposing wall surfaces 68, 70. The scraping portion 66 has an edge 67. The scraper head 64 may be attached to the handle 62 or the handle 62 may be bent at an angle to permit the user to more easily follow the contour of the watermelon 2 while scraping the fleshy interior 7 of the watermelon 2.

To remove the remaining fleshy part 7 of the watermelon 2 after the slicer device 10, 102, 104 has been used, a user aligns the edge 67 of the scraper head 64 with the fleshy part 7 of the watermelon 2 and pulls the scraper 60, such that the edge 67 cuts through the fleshy part 7 of the watermelon 2 from the rind 8 in a manner similar to FIG. 9. The fleshy part 7 of the watermelon 2 that is cut or scraped off, slides across the top surface 69 of the scraper head 64 and is cut into shaped pieces based on the placement of the opposing wall surfaces 68, 70 and the connecting portion 72 relative to the top surface 69 of the scraper head 64. The bend in the handle 62 allows the user to move easily follow the contour of the rind 8 to remove what fleshy interior 7 of the melon 2 is desired.

After the slicer device 10 has been pushed through the fleshy part or meat 7 of the watermelon 2, the meat 7 of the watermelon 2 may be lodged within the slicer device 10. To easily remove the meat 7 of the watermelon lodged within the slicer device 10, the blades 22 or cutter piece 16 of the slicer device 10 are aligned with the grooves 32 of the push plate 30 and as the slicer device is pushed down onto the plate 30, such that the cutters 22 are received by the grooves 32 of the push plate. The downward movement of the slicer device 10 relative to the push plate causes the raised portions 34 to push the fleshy part of the melon out of the openings 24 between the blades 22 and the cutter piece 16. The raised portions 34 defining the grooves 32 push the meat 7 of the watermelon out of the openings 24 between the cutters 22 and the cutter piece 16 without having a user place their fingers near the cutting edges of the slicer device.

The scraper 50 and the slicer device 10 are preferably made of stainless steel, although other materials may also be used. The push plate is preferably made of plastic, stainless steel, or other non-porous metals.

Accordingly, it is to be understood that the embodiments of the invention herein described are merely illustrative of the application of the principles of the invention. Reference herein to details of the illustrated embodiments is not intended to limit the scope of the claims, which themselves recite those features regarded as essential to the invention.

1. A slicer device for slicing and removing a fleshy part of a watermelon surrounded by a rind comprising:
a cutter piece having an outer surface and an inner surface; and
a series of cutters of a thickness attached to the inner surface of the cutter piece spaced apart, connected to each other and arranged to form a pattern with openings, the openings defined by the cutters and the inner surface of the cutter piece for receiving and slicing the fleshy part of the watermelon from the rind.

2. The slicer device of claim 1, further comprising at least one support bar of a thickness attached to the cutter piece, wherein the thickness of the at least one support bar is less than or equal to the thickness of the series of cutters.

3. The slicer device of claim 2, further comprising at least one handle attached to the at least one support bar.

4. The slicer device of claim 1, further comprising at least one support bar of a thickness attached to the series of cutters.

5. The slicer device of claim 4, further comprising at least one handle attached to the at least one support bar.

6. The slicer device of claim 1, wherein the cutter piece has a cutting edge.

7. The slicer device of claim 1, wherein the cutters are blades.

8. The slicer device of claim 1, wherein the cutters are wires.

9. The slicer device of claim 2, wherein a first end of the at least one support bar has a cutting edge.

10. The slicer device of claim 4, wherein a first end of the at least one support bar has a cutting edge.

11. The slicer device of claim 1, further comprising a push plate comprising:
a base portion;
a plurality of raised portions integrally formed with the base portion and extending axially outward from the base portion at a height; and
a series of grooves formed between the plurality of raised portions;
wherein the plurality of raised portions are received by the openings defined between the cutters and the openings defined between the inner surface of the cutter piece and the cutters are received by the series of grooves.

12. The slicer device of claim 1, further comprising: a handle; and a scraper head mounted to the handle, the scraper head having a top surface, a bottom surface, opposing wall surfaces, and an edge.

13. The slicer device of claim 1, further comprising a handle integrally formed with a bent scraping portion, the bent scraping portion having a bottom surface, a top surface, and opposing wall surfaces.

14. The slicer device of claim 13, wherein the handle is bent relative to the bent scraping portion.

15. The slicer device of claim 1, further comprising a detachable cutter piece, larger than the cutter piece and removeably attached to the cutter piece comprising a series of cutters.

16. A method of slicing and removing a fleshy part of a watermelon with a slicer comprising the steps of:
removing a crown portion from a top and a bottom of the watermelon to expose the fleshy part of the watermelon and form a flat top portion and a flat top portion;
aligning a slicer device comprising: a cutter piece having an outer surface and an inner surface; a series of cutters of a thickness attached to the inner surface of the cutter piece spaced apart, connected to each other and arranged to form a pattern with openings, the openings defined by the cutters and the inner surface of the cutter piece for receiving and slicing the fleshy part of the watermelon from the rind; and at least one support bar attached to the cutter piece;
pushing the at least one support bar attached to the cutter piece of the slicer device through the fleshy part of the watermelon and the flat bottom portion of the watermelon in a straight, linear action without simultaneous rotation of the slicer device, to remove the fleshy part from the rind of the watermelon without cutting through the rind of the watermelon and slice the fleshy part of the watermelon into shaped pieces corresponding to the openings between the cutters and the openings between the cutters and the inner surface of the cutter piece.

17. The method of claim 16, further comprising, after pushing the cutter piece of the slicer device through fleshy part of the watermelon, the step of scraping any remaining fleshy part from the rind using a scraper.

18. The method of claim 17, wherein the scraper comprises: a handle; and a scraper head mounted to the handle, the scraper head having a top surface, a bottom surface, opposing wall surfaces, and an edge.

19. The method of claim 16, wherein the cutters are blades.

20. The method of claim 16, wherein the cutters are wires.

21. The method of claim 16, further comprising, after the step of pushing the at least one support bar attached to the cutter piece of the slicer device through the fleshy part of the watermelon and the flat bottom portion of the watermelon, the step of:
aligning the slicer device containing the sliced fleshy part of the watermelon with a push plate comprising: a base portion; a plurality of raised portions integrally formed with the base portion and extending axially outward from the base portion at a height; and a series of grooves formed between the plurality of raised portions, such that the plurality of raised portions contact the fleshy part of the watermelon within the cutter piece of the slicer device;
pushing the at least one support bar attached to the cutter piece of the slicer device, until the cutter blades are received by the series of grooves formed between the plurality of raised portions of the push plate and the openings within the inner surface of the cutter piece are received by the plurality of raised portions of the push plate to remove the fleshy part of the watermelon from the slicer device.

22. A slicer device for slicing and removing a fleshy part of a watermelon surrounded by a rind comprising:
a cutter piece having an outer surface with a cutting edge for slicing the fleshy part of the watermelon from the rind and an inner surface defining an opening for receiving the fleshy part of the watermelon; and
at least one support bars attached to the cutter piece.

23. The slicer device of claim 22, further comprising a handle attached to the at least one support bar.

24. The slicer device of claim 22, wherein the at least one support bar is integrally formed with a handle.

25. The slicer device of claim 22, wherein the at least one support bar is integrally formed with the cutter piece.

26. The slicer device of claim 22, further comprising: a handle; and a scraper head mounted to the handle, the scraper head having a top surface, a bottom surface, opposing wall surfaces, and an edge.

27. The slicer device of claim 22, further comprising a handle integrally formed with a bent scraping portion, the bent scraping portion having a bottom surface, a top surface, and opposing wall surfaces.

28. The slicer device of claim 27, wherein the handle is bent relative to the bent scraping portion.

29. A method of slicing and removing a fleshy part of a watermelon with a slicer comprising the steps of:
removing a crown portion from a top and a bottom of the watermelon to expose the fleshy part of the watermelon and form a flat top portion and a flat top portion;
aligning a slicer device comprising: a cutter piece having an outer surface with a cutting edge for slicing the fleshy part of the watermelon from the rind and an inner surface defining an opening for receiving the fleshy part of the watermelon for receiving the fleshy part of the watermelon; and at least one support bar attached to the cutter piece, with the exposed fleshy part of the watermelon of the flat top portion; and
pushing the at least one support bar attached to the cutter piece of the slicer device through the fleshy part of the watermelon and the flat bottom portion of the watermelon in a straight, linear action without simultaneous rotation of the slicer device, to remove the fleshy part from the rind of the watermelon without cutting through the rind of the watermelon and slice the fleshy part of the watermelon into pieces corresponding to the inner surface of the cutter piece.

30. The method of claim 29, further comprising, after pushing the cutter piece of the slicer device through fleshy part of the watermelon, the step of scraping any remaining fleshy part from the rind using a scraper.
